(19) United States
(12) Patent Application Publication
(10) Pub. No.: US 2024/0262384 A1
(43) Pub. Date: Aug. 8, 2024

(54) TRAVELING CONTROL SYSTEM

(71) Applicants: TOYOTA JIDOSHA KABUSHIKI KAISHA, Toyota-shi (JP); KOMATSU LTD., Tokyo (JP)

(72) Inventors: Yusuke NOZAWA, Atsugi-shi (JP); Shun Mizoo, Zama-shi (JP); Toru Takashima, Susono-shi (JP); Takahiro Okano, Chiryu-shi (JP); Takashi Hiranaka, Tokyo (JP); Kenta Osagawa, Tokyo (JP); Shota Konishi, Tokyo (JP)

(73) Assignees: TOYOTA JIDOSHA KABUSHIKI KAISHA, Toyota-shi (JP); KOMATSU LTD., Tokyo (JP)

(21) Appl. No.: 18/422,553

(22) Filed: Jan. 25, 2024

(30) Foreign Application Priority Data
Feb. 3, 2023 (JP) 2023-015094

(51) Int. Cl. B60W 60/00; B60W 40/06

(52) U.S. Cl. CPC B60W 60/001; B60W 40/06; B60W 2520/10; B60W 2552/20

(57) ABSTRACT

A traveling control system configured to control traveling of a movable body includes: a traveling control portion configured to control traveling of the movable body such that a wheel of the movable body passes a protrusion of a road surface, based on an unevenness condition of the road surface of a travel region where the movable body travels.

### REFERENCE TO RELATED APPLICATIONS

This application claims priority from Japanese Patent Application No. 2023-015094 filed on Feb. 3, 2023. The entire content of the priority application is incorporated herein by reference.

### BACKGROUND ART

The present disclosure relates to a traveling control system configured to control traveling of a movable body.

Patent Document 1 (Japanese Patent Application Publication No. 2021-157374) describes that each of a plurality of movable bodies travels by changing a target route of each movable body based on mutually common offset information. This prevents large protrusions and recesses (unevenness) from being generated on a road surface.

### DESCRIPTION

Accordingly, an aspect of the present disclosure relates to an improvement in a road surface condition of a travel region where a movable body travels.

In the traveling control system according to the present disclosure, traveling of the movable body is controlled such that a wheel of the movable body passes the protrusion of the road surface, based on the unevenness condition of the road surface. This makes it possible to reduce the size (height) of a protrusion of the road surface, so that unevenness of the road surface is leveled. Thus, the road surface condition of the travel region is improved.

The objects, features, advantages, and technical and industrial significance of the present disclosure will be better understood by reading the following detailed description of embodiments, when considered in connection with the accompanying drawings, in which:

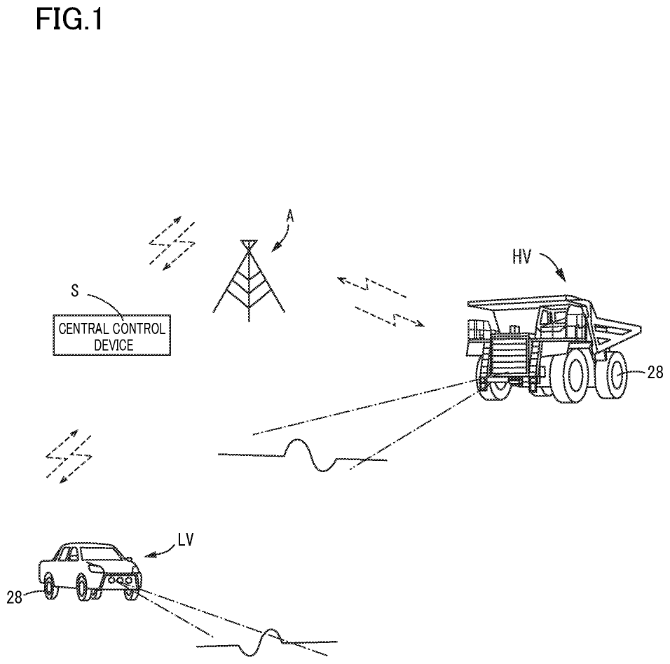

FIG. 1 is a view conceptually illustrating a whole traveling control system according to one embodiment of the present disclosure;

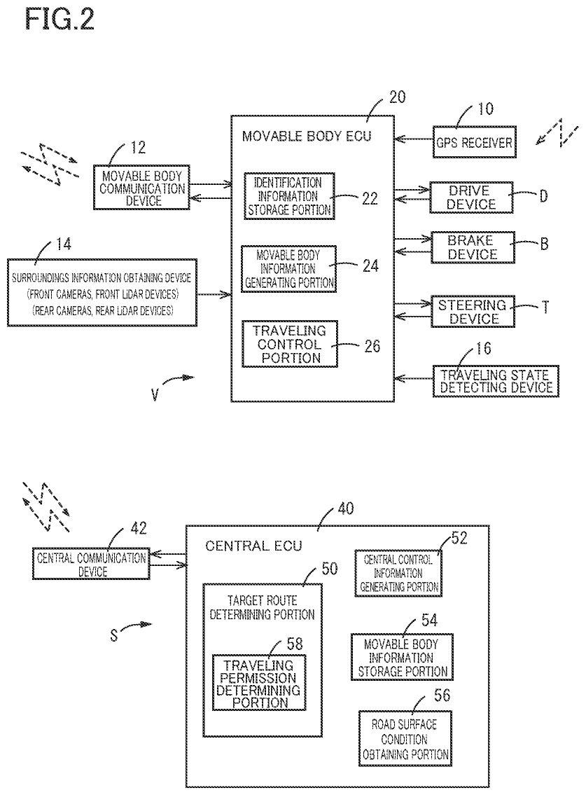

FIG. 2 is a view conceptually illustrating a configuration of a central control device of the traveling control system and a configuration of a movable body;

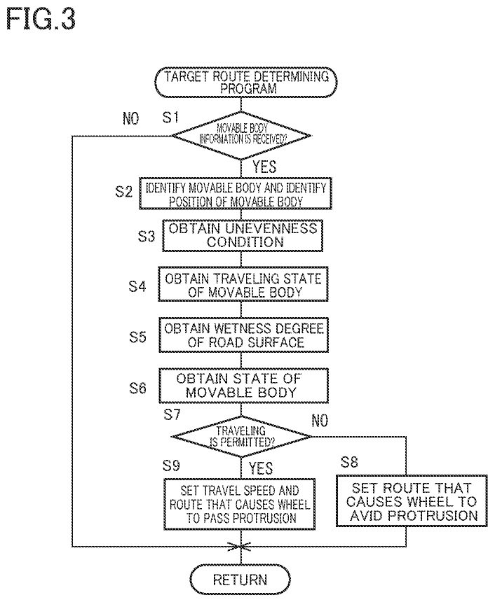

FIG. 3 is a flowchart conceptually illustrating part of a target route determining program executed in a central ECU of the central control device;

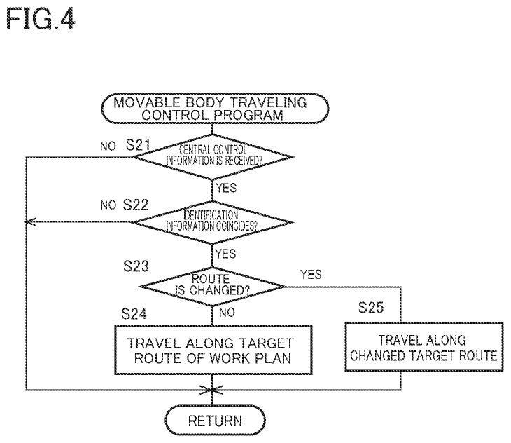

FIG. 4 is a flowchart of a traveling control program executed in a movable body ECU of the movable body;

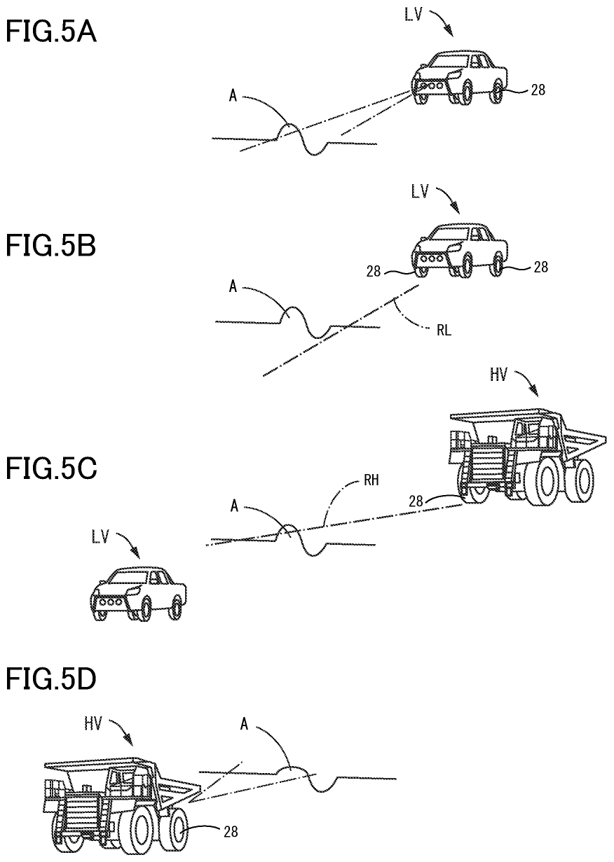

FIG. 5A is a view conceptually illustrating a state in which the movable body detects a protrusion and a recess (unevenness) of a road surface;

FIG. 5B is a view conceptually illustrating a target route of the movable body;

FIG. 5C is a view conceptually illustrating a target route of the movable body;

FIG. 5D is a view conceptually illustrating a state in which the protrusion of the road surface is detected after a wheel has passed the protrusion;

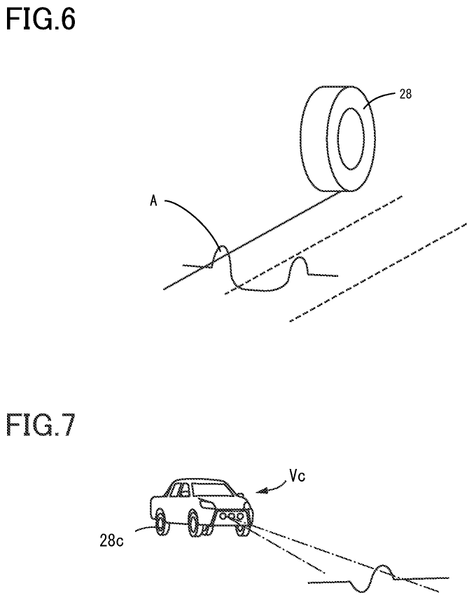

FIG. 6 is a view conceptually illustrating a route of the wheel of the movable body;

FIG. 7 is a view conceptually illustrating a movable body according to another embodiment; and

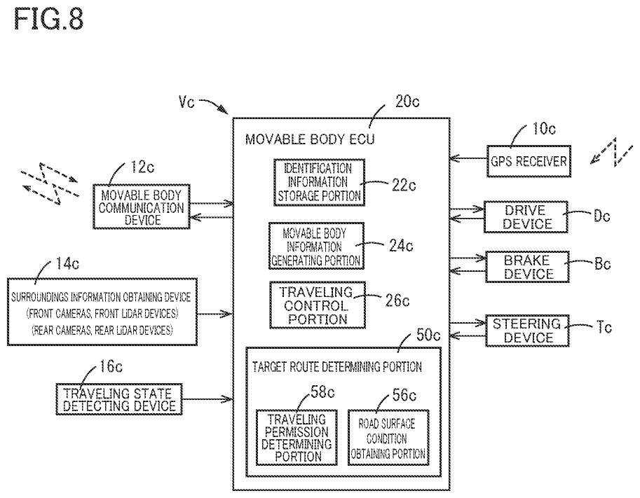

FIG. 8 is a view conceptually illustrating a configuration of the movable body of FIG. 7.

Referring to the drawings, there will be described below a traveling control system according to an embodiment of the present disclosure.

### FIRST EMBODIMENT

As illustrated in FIG. 1, the traveling control system according to a first embodiment includes a central control device S and one or more antennas A. The central control device S is communicable with a plurality of movable bodies V that works in mountainous regions such as mines, for instance. The plurality of movable bodies V and the central control device S perform wireless communication directly or via the antenna A.

The plurality of movable bodies V includes one or more heavy machines (heavy equipment) HV and one or more light vehicles LV. In the present embodiment, the heavy machine HV and the light vehicle LV will be collectively or individually referred to as the movable body V where appropriate.

Each heavy machine HV is a machine used in heavy industries. In the present embodiment, the heavy machine HV is a movable body that works in mines. The heavy machine HV is operated or moved based on a command from the central control device S. The heavy machine HV is an automated traveling movable body.

Each light vehicle LV is a movable body with a smaller weight than the heavy machine HV. The light vehicle LV usually travels with workers on board or travels carrying loads necessary for the work. The light vehicle LV in the present embodiment is an automated driving movable body (automated traveling movable body) capable of traveling without a driver's driving operation. The light vehicle LV may be a manual driving movable body capable of traveling by a driver's driving operation.

As illustrated in FIG. 2, each movable body V includes, for instance, a drive device D for driving the movable body V, a brake device B for braking the movable body V, a steering device T for steering steerable wheels of the movable body V, a global positioning system (GPS) receiver 10, a surroundings information obtaining device 14, a movable body communication device 12, a traveling state detecting device 16, and a movable body ECU 20.

The drive device D may include one or more electric motors each functioning as a drive source and connected to a plurality of drive wheels among a plurality of wheels 28. Further, a drive circuit (such as an inverter) is provided so as to correspond to the electric motor. By controlling the drive circuit, the drive force applied to the plurality of drive wheels is controlled, and the drive force applied to the movable body V is automatically controlled.

The drive device D may include an engine in addition to or in place of the electric motor.

The brake device B may be configured to include: a plurality of friction brakes each provided for a corresponding one of the plurality of wheels 28 to decrease rotation of the wheel 28 by pressing friction engagement members against a brake rotary body that is rotatable integrally with the wheel 28; and a pressing force control actuator for controlling a pressing force of each friction brake. By controlling the pressing force control actuator, the pressing force of the friction brakes provided for the respective wheels 28 is controlled, so that the braking force applied to each wheel 28 is controlled and the braking force applied to the movable body V is automatically controlled. Force of regenerative braking may be applied to the wheels 28 by braking of the electric motor of the drive device D.

The steering device T steers the steerable wheels among the plurality of wheels 28. The steering device T includes, for instance, a pair of tie rods connecting the right and left steerable wheels, a steering rod connecting the pair of tie rods, and a steering actuator provided for the steering rod. The steering rod is moved by the steering actuator in the width direction of the vehicle, so that the right and left steerable wheels are steered automatically.

The GPS receiver 10 receives signals from the GPS (e.g., the GPS signals). The GPS is one example of a global navigation satellite system (GNSS). Based on the GPS signals, the position of an own movable body V that is the movable body itself is obtained. Based on the GPS signals, the three-dimensional position of the own movable body V represented by the latitude, the longitude, and the altitude or two-dimensional position of the own movable body V represented by the latitude and the longitude may be obtained.

The surroundings information obtaining device 14 includes a plurality of cameras (stereo camera), a plurality of light detection and ranging or laser imaging detection and ranging (LiDAR) devices. The surroundings information obtaining device 14 recognizes a condition of unevenness (protrusions and recesses) of the road surface around the own movable body and an object present around the own movable body. The surroundings information obtaining device 14 of the present embodiment includes a front information obtaining portion and a rear information obtaining portion. The front information obtaining portion includes front cameras, front LiDAR devices, etc., disposed at a front portion of the movable body V so as to face frontward. The front information obtaining portion obtains the unevenness condition of the road surface ahead of the movable body V. The rear information obtaining portion includes rear cameras, rear LiDAR devices, etc., disposed at a rear portion of the movable body V so as to face rearward. The rear information obtaining portion obtains the unevenness condition of the road surface behind the movable body. The surroundings information obtaining device 14 obtains the recognized degree of the unevenness of the road surface, namely, the height and the width of the protrusion.

The movable body communication device 12 wirelessly transmits movable body information generated by the movable body ECU 20 and receives central control information that is information wirelessly transmitted from the central control device S.

The traveling state detecting device 16 detects a traveling state of the movable body V. The traveling state detecting device 16, detects, as the traveling state, longitudinal acceleration, longitudinal travel speed, lateral acceleration, etc.

The movable body ECU 20 is constituted mainly by a computer. There are connected, to the movable body ECU 20, the drive circuit of the drive device D, the pressing force control actuator of the brake device B, the steering actuator of the steering device T, the GPS receiver 10, the surroundings information obtaining device 14, the movable body communication device 12, and the traveling state detecting device 16. The movable body ECU 20 includes an identification information storage portion 22, a movable body information generating portion 24, and a traveling control portion 26.

The identification information storage portion 22 stores identification information set for the own movable body V. Mutually different identification information is given to the heavy machines HV and the light vehicles LV.

The movable body information generating portion 24 generates movable body information including movable body positional information, road surface unevenness information, traveling state information, and the identification information of the own movable body V. The movable body positional information indicates the position of the own movable body V obtained based on the GPS signals. The road surface unevenness information indicates the unevenness condition of the road surface ahead of and behind the own movable body V obtained by the surroundings information obtaining device 14. The traveling state information indicates the traveling state of the own movable body V detected by the traveling state detecting device 16. The generated movable body information is output to the movable body communication device 12. The movable body communication device 12 transmits the movable body information.

The traveling control portion 26 controls traveling of the own movable body V by controlling the drive device D, the brake device B, the steering device T. The traveling control portion 26 of the present embodiment controls the drive device D, the brake device B, and the steering device T such that the own movable body V travels according to a target route included in the central control information received by the movable body communication device 12 and transmitted from the central control device S.

In a case where a road surface sensor is provided for the tire of each wheel 28 of the movable body V, the road surface condition is detected by the road surface sensors. The road surface condition detected by the road surface sensors may include, for instance, a dry condition of the road surface, a water content of the road surface, and a friction coefficient of the road surface. In a case where the road surface sensor has a communication function or in a case where the tire is provided with a communication device that can transmit a detection result of the road surface sensor, the detection result of the road surface sensor can be supplied to the vehicle body side by wireless communication between the tire and the vehicle body. The movable body ECU 20 generates the movable body information including information that represents the road surface condition detected by the road surface sensors.

As illustrated in FIG. 2, the central control device S includes a central ECU 40 constituted mainly by a computer and a central communication device 42 connected to the central ECU 40. The central ECU 40 includes a target route determining portion 50, a central control information generating portion 52, a movable body information storage portion 54, a road surface condition obtaining portion 56, etc. The target route determining portion 50 includes a traveling permission determining portion 58.

The central communication device 42 wirelessly transmits the central control information generated by the central control information generating portion 52 and receives the movable body information wirelessly transmitted from the movable body V.

The movable body information storage portion 54 stores various kinds of information of each of the movable bodies V. The information of the movable body includes the weight of the movable body V, the loading weight (including occupants), the roll stiffness of the movable body V, the size of the wheel 28, the standard vehicle height, the rigidity of the vehicle body. The information of the movable body V is input and stored before a series of work starts. The information of each movable body V is stored in association with the identification information of each movable body V.

The road surface condition obtaining portion 56 obtains the road surface condition of the travel region where the movable bodies travel. The road surface condition includes the unevenness condition of the road surface, the wetness degree of the road surface (the water content of the road surface), the quality of the road surface, etc. The unevenness condition of the road surface such as the size (height) of the protrusion is obtained based on the road surface unevenness information included in the movable body information transmitted from the movable body V. The quality of the road surface (such as a high content of rocks or a high content of earth and sand) is input beforehand. The wetness degree of the road surface is obtained based on meteorological information transmitted from an external information transmitting device (not illustrated) and the quality of the road surface. The road surface condition may be referred to as the condition of the protrusion of the road surface. Based on the wetness degree of the road surface, the softness (the ease of collapse) of the protrusion of the road surface is obtained.

The information on the degree of the unevenness of the road surface may be directly input to the central control device S by a worker. For instance, while the movable body V is traveling, the worker visually checks and actually measures the unevenness of the road surface to input the information to the central control device S.

In a case where the movable body V includes the road surface sensors and the movable body information includes the detection results of the road surface sensors, the wetness degree of the road surface (the water content of the road surface) can be obtained based on the detection results of the road surface sensors included in the movable body information.

The traveling permission determining portion 58 determines whether traveling of the movable body V in which the wheel 28 passes the protrusion of the road surface is permitted, based on: the unevenness condition of the road surface ahead of the movable body V, the wetness degree (the softness) of the road surface, and the quality of the road surface; and the gross weight of the movable body V (i.e., the sum of the weight of the movable body V and the loading weight), the size of the wheel 28, and the load applied to the wheel 28, for instance. In a case where the loading weight is small with respect to the weight of the movable body V, the determination as to whether the movable body V is permitted to travel may be made based on the weight of the movable body V. The same applies hereinafter.

In a case where the wheel 28 is small and the gross weight of the movable body is small with respect to the size and the hardness of the protrusion, it is difficult for the movable body V to travel such that the wheel 28 passes the protrusion. In this case, the movable body V is not permitted to travel such that the wheel 28 passes the protrusion. If the movable body V travels such that the wheel 28 passes the protrusion, the movable body V may suffer from a large burden. Further, the effect of collapsing the protrusion, i.e., the effect of reducing the size of the protrusion, is not sufficiently obtained.

On the other hand, in a case where the protrusion is small or the protrusion is soft, the movable body V is permitted to travel such that the wheel 28 passes the protrusion even if the wheel 28 is small and the gross weight of the movable body V is small. In this case, the movable body V does not suffer from a large burden, and the effect of collapsing the protrusion, i.e., the effect of reducing the size of the protrusion, is sufficiently obtained.

In a case where the load applied to the wheel 28 is great, the movable body V is permitted to travel such that the wheel 28 passes the protrusion even if the protrusion is high (big) and hard, as compared with a case where the load applied to the wheel 28 is small. The load applied to the wheel 28 is obtained based on the gross weight of the movable body V, the turning state of the movable body V, etc. For instance, the load applied by the load shift to a turning outer wheel, which is a wheel located on the outer side in turning of the movable body V, is greater than the load applied to a turning inner wheel, which is a wheel located on the inner side in turning of the movable body V. This is because, in the turning state of the movable body V, the centrifugal force is applied to the movable body V, and roll moment is generated. In the turning state of the movable body V, the load applied to the turning outer wheel is determined based on the roll stiffness, the turning radius, the gross weight of the movable body V, etc.

The target route determining portion 50 determines at least one of the target route and the travel speed of at least one of the movable bodies V. The target route and the travel speed of the movable body V may differ from the target route and the travel speed determined in the work plan. In this instance, the target route and the travel speed determined in the work plan are suitably changed.

The travel route and the travel speed of the movable body V are determined when the traveling permission determining portion 58 permits traveling of the movable body V in which the wheel 28 passes the protrusion. The protrusion can be collapsed more effectively in a case where the travel speed when the wheel 28 passes the protrusion is low than in a case where the travel speed when the wheel 28 passes the protrusion is high. Thus, the travel speed is set in consideration of the load applied to the wheel 28, the softness of the protrusion, the effect of collapsing the protrusion achieved by the wheel 28 as a result of passing the protrusion, the work efficiency (the traveling time), etc.

The central control information generating portion 52 generates the central control information including information indicating the target route determined by the target route determining portion 50 and the identification information of the movable body. The generated central control information is output to the central communication device 42. The central communication device 42 transmits the central control information.

In the traveling control system constructed as described above, the target route determining portion 50 of the central control device S executes a target route determining program represented by a flowchart of FIG. 3 every time a set time elapses.

At Step 1, it is determined whether the movable body information is obtained. Hereinafter, Step 1 will be abbreviated as “S1”. Other steps will be similarly abbreviated. When an affirmative determination (YES) is made, the control flow proceeds to S2 at which the movable body V is identified and the position of the movable body V is identified based on the movable body information. At S3, the unevenness condition of the road surface ahead of the movable body V is obtained. At S4, the traveling state of the movable body V is obtained. When the movable body V is turning, the turning state (such as the turning radius and lateral acceleration) is obtained. At S5, the water content of the road surface is estimated based on the meteorological information. At S6, the state of the movable body V (the movable body information) is obtained based on the identification information of the movable body V. At S7, it is determined whether traveling of the movable body V in which the wheel 28 passes the protrusion is permitted based on the road surface condition (that may be referred to as the condition of the protrusion of the road surface and that includes the size of the protrusion of the road surface, the wetness degree of the protrusion, etc.,) and the state of the movable body V. When a negative determination (NO) is made, the control flow proceeds to S8 at which the target route of the movable body V is determined such that the wheel 28 does not pass the protrusion as indicated by the dashed line in FIG. 6. When an affirmative determination (YES) is made, the control flow proceeds to S9 at which the target route of the movable body V is determined such that the wheel 28 passes the protrusion as indicated by the solid line in FIG. 6. It is noted that the travel speed of the movable body V is set at S9.

The movable body ECU 20 executes a movable body traveling control program represented by a flowchart of FIG. 4 every time a set time elapses.

At S21, it is determined whether the central control information is received. When an affirmative determination (YES) is made, the control flow proceeds to S22 at which own identification information coincides with the identification information included in the central control information. When an affirmative determination (YES) is made, it is determined at S23 whether the target route is changed from the route determined in the work plan. When a negative determination (NO) is made, the control flow proceeds to S24 at which the steering device T, the drive device D, and the brake device B are controlled such that the movable body travels along the route determined in the work plan. When an affirmative determination (YES) is made, the steering device T, the drive device D, the brake device B are controlled such that the movable body travels along the changed route. In this respect, the target speed may be changed. In any case, the drive device D and the brake device B are controlled such that the movable body travels at the determined travel speed.

A case is considered in which a light vehicle LV that is the movable body V obtains the unevenness of the road surface ahead of the light vehicle LV, as illustrated in FIG. 5A. In this case, when the traveling permission determining portion 58 does not permit traveling of the movable body V in which the wheel 28 passes a protrusion A, the target route of the light vehicle LV is determined to be a route that causes the wheel 28 to avoid the protrusion A, as indicated by a long dashed short dashed line RL in FIG. 5B. On the other hand, a heavy machine HV is permitted to travel such that the wheel 28 passes the protrusion A, as illustrated in FIG. 5C. Thus, the target route of the heavy machine HV is determined to be a route that causes the wheel 28 to pass the protrusion A, as indicated by a long dashed short dashed line RH.

As illustrated in FIG. 5D, it is confirmed that the height of the protrusion A is reduced after the wheel 28 of the heavy machine HV has passed the protrusion A, based on the unevenness condition of the road surface behind the heavy machine HV included in the movable body information after traveling of the heavy machine HV along the route RH. Thus, the central control device S obtains the degree of effect of collapsing the protrusion A by the heavy machine HV, and it is possible to grasp the road surface condition at that time point in detail.

After the heavy machine HV has traveled, the light vehicle LV can travel, so that the height of the protrusion A can be further reduced and the unevenness of the road surface can be leveled.

As described above, as many the movable bodies V as possible travel along the route that causes the wheel 28 to pass the protrusion A. This enables a reduction in the size of the protrusion A, and the unevenness of the road surface can be leveled, so that the road surface condition can be improved.

The protrusion A can be made small in the work performed by the plurality of movable bodies V, thus allowing a reduction in frequency of operating a grader. Further, it is possible to prevent traveling of the movable body V from becoming difficult due to the unevenness of the road surface. Accordingly, the movable bodies V can appropriately travel, leading to an improvement in the work efficiency of the movable bodies V.

In the present embodiment, the unevenness condition of the road surface is actually detected, and traveling of the movable body V is controlled such that the wheel 28 passes the protrusion. As compared with the system of the Patent Document 1 described above, the system of the present embodiment can level the unevenness of the road surface more effectively and can improve the road surface condition.

In the present embodiment, a traveling control portion is constituted by the target route determining portion 50, the central control information generating portion 52, and the central communication device 42 of the central ECU 40 of the central control device S, for instance. The traveling control portion may include the traveling control portion 26 of the movable body ECU 20 of the movable body V.

### SECOND EMBODIMENT

The target route determining portion 50 may be disposed in a movable body Vc, as illustrated in FIGS. 7 and 8. In the traveling control system according to a second embodiment, each movable body Vc includes a movable body communication device 12c, a surroundings information obtaining device 14c, a GPS receiver 10c, a traveling state detecting device 16c, a drive device Dc, a brake device Bc, a steering device Tc, and a movable body ECU 20c. The movable body ECU 20c includes an identification information storage portion 22c, a movable body information generating portion 24c, a traveling control portion 26c, and a target route determining portion 50c. The target route determining portion 50c includes a road surface condition obtaining portion 56c and a traveling permission determining portion 58c. The movable body communication device 12c, etc., are identical in configuration to the movable body communication device 12, etc., in the first embodiment, a description of which is dispensed with.

The traveling permission determining portion 58c determines whether traveling of the own movable body Vc in which the wheel 28c passes the protrusion is permitted, based on the road surface condition obtained by the road surface condition obtaining portion 56c, the state of the own movable body Vc such as the gross weight of the own movable body Vc and the size of the wheel 28c, and the traveling state of the own movable body Vc.

When traveling of the own movable body Vc in which the wheel 28c passes the protrusion is permitted, the target route determining portion 50c determines the target route and the travel speed of the own movable body Vc such that the wheel 28c passes the protrusion. When traveling of the own movable body Vc in which the wheel 28c passes the protrusion is not permitted, the target route determining portion 50c determines the target route of the own movable body Vc such that the wheel 28c avoids the protrusion.

The traveling control portion 26c controls the drive device Dc, the brake device Bc, and the steering device Tc such that the own movable body Vc travels along the determined target route.

Thus, the present disclosure is applicable to not only works in mines but also traveling of the movable body on rough roads. In the second embodiment, the road surface condition of the travel region where the movable body Vc travels can be improved, enabling the movable body Vc to travel appropriately.

In the second embodiment, the traveling control portion is constituted by the target route determining portion 50c, the traveling control portion 26c, the surroundings information obtaining device 14c, etc., of the movable body ECU 20c. The central control device S is not essential.

It is to be understood that the present disclosure may be embodied with various changes and modifications, which may occur to those skilled in the art.

### Claimable Invention

There will be hereinafter described forms of a claimable invention.

(1) A traveling control system configured to control traveling of a movable body, including: a traveling control portion configured to control traveling of the movable body such that a wheel of the movable body passes a protrusion of a road surface, based on an unevenness condition of the road surface of a travel region where the movable body travels.

(2) The traveling control system according to the form (1), wherein the traveling control portion determines whether traveling of the movable body in which the wheel of the movable body passes the protrusion is permitted, based on at least one of a state of the movable body and a condition of the road surface.

The state of the movable body includes the weight of the movable body, the loading weight, the rigidity of the movable body, the roll stiffness, and the size of the wheel, for instance. The road surface condition includes the unevenness condition of the road surface such as the size (height) of the protrusion, the water content (the wetness degree) of the road surface or the protrusion, the quality of the road surface or the protrusion (such as a high content of rocks or a high content of earth and sand).

(3) The traveling control system according to the form (1) or (2), wherein, where traveling of the movable body in which the wheel of the movable body passes the protrusion is not permitted, the traveling control portion determines a travel route of the movable body to be a route that causes the wheel to avoid the protrusion, and wherein, where traveling of the movable body in which the wheel of the movable body passes the protrusion is permitted, the traveling control portion determines the travel route of the movable body to be a route that causes the wheel to pass the protrusion.

When traveling of the movable body in which the wheel passes the protrusion is not permitted, the travel route of the movable body is determined such that the wheel avoids the protrusion. This enables the movable body to be less likely to suffer from a large burden.

(4) The traveling control system according to any one of the forms (1)-(3), wherein, where traveling of the movable body in which the wheel of the movable body passes the protrusion is permitted, the traveling control portion controls a travel speed of the movable body.

(5) The traveling control system according to any one of the forms (1)-(4), wherein, where traveling of the movable body in which the wheel of the movable body passes the protrusion is permitted, the traveling control portion determines a travel speed of the movable body based on at least one of a state of the movable body and a condition of the road surface.

In a case where the gross weight of the movable body is large, the wheel reduces the height of the protrusion more effectively and the unevenness of the road surface is leveled more effectively when the travel speed of the movable body is low than when the travel speed is high.

(6) The traveling control system according to any one of the forms (1)-(5), wherein the traveling control portion determines a travel speed of the movable body based on a load applied to the wheel.

The load applied to the wheel is determined based on the gross weight of the movable body, the turning state of the movable body, and the roll stiffness, for instance.

(7) The traveling control system according to any one of the forms (1)-(6), wherein the traveling control portion controls traveling of the movable body such that a turning outer wheel of the movable body, which is located on an outer side in a turning state of the movable body, passes the protrusion of the road surface in the turning state of the movable body.

In turning of the movable body, the centrifugal force acts on the movable body, and roll moment is applied to the movable body. Accordingly, the load applied to the turning outer wheel is great, and the load applied to a turning inner wheel, which is located on an inner side in the turning state of the movable body, is small. Thus, the size (height) of the protrusion can be more effectively reduced when the turning outer wheel passes the protrusion of the road surface.

It is possible to determine which one of the turning outer wheel and the turning inner wheel passes the protrusion based on the quality of the protrusion of the road surface (soft or not), the size (height) of the protrusion, etc.

(8) The traveling control system according to any one of the forms (1)-(7), wherein the traveling control portion is disposed in a central control device that manages the movable body, wherein the traveling control system includes a communication system that performs communication of information between the central control device and the movable body, wherein the communication system includes a movable body communication device disposed in the movable body and a central communication device disposed in the central control device, wherein the movable body includes a surroundings information obtaining device configured to obtain the unevenness condition of the road surface around an own movable body that is the movable body, wherein the movable body communication device transmits movable body information including road surface unevenness information that is obtained by the surroundings information obtaining device and that indicates the unevenness condition of the road surface around the own movable body, and wherein the traveling control portion controls traveling of the movable body based on the unevenness condition of the road surface that is obtained from the movable body information received by the central communication device.

(9) The traveling control system according to the form (8), wherein the surroundings information obtaining device includes a rear information obtaining portion configured to obtain the unevenness condition of the road surface behind the own movable body, and wherein the movable body communication device transmits the movable body information including information that is obtained by the rear information obtaining portion and that indicates a condition of the road surface after the wheel of the own movable body passes.

The central control device can grasp the latest road surface condition. Further, it is possible to grasp the degree of collapse (the degree of size reduction) of the protrusion after the wheel of the movable body has passed the protrusion.

(10) The traveling control system according to any one of the forms (1)-(9), wherein the movable body includes: a rear information obtaining portion configured to obtain a condition of the road surface after the wheel passes; and a rear information supply portion configured to supply, to the traveling control portion, information that is obtained by the rear information obtaining portion and that indicates the unevenness condition of the road surface behind the movable body.

In the first embodiment, the movable body communication device 12 corresponds to the rear information supply portion. In the second embodiment, an information line connecting the surroundings information obtaining device 14c and the movable body ECU 20c correspond to the rear information supply portion.

(11) The traveling control system according to any one of the forms (1)-(10), wherein the traveling control portion estimates a size of a protrusion of the road surface after the wheel passes the protrusion, based on at least one of a condition of the road surface and a state of the movable body.

In a case where the movable body does not include the rear information obtaining portion, the size (height) of the protrusion after the wheel passes the protrusion is estimated based on the condition of the road surface or the protrusion (such as the wetness degree of the road surface and the quality of the road surface) and the state of the movable body (the load applied to the wheel that passes the protrusion of the road surface). For instance, it can be estimated that the size (height) of the protrusion is reduced when the road surface is soft and the load applied to the wheel is large than when the road surface is hard and the load applied to the wheel is small.

What is claimed is:

1. A traveling control system configured to control traveling of a movable body, comprising:
a traveling control portion configured to control traveling of the movable body such that a wheel of the movable body passes a protrusion of a road surface, based on an unevenness condition of the road surface of a travel region where the movable body travels.

2. The traveling control system according to claim 1, wherein the traveling control portion determines whether traveling of the movable body in which the wheel of the movable body passes the protrusion is permitted, based on at least one of a state of the movable body and a condition of the road surface.

3. The traveling control system according to claim 1,
wherein, where traveling of the movable body in which the wheel of the movable body passes the protrusion is not permitted, the traveling control portion determines a travel route of the movable body to be a route that causes the wheel to avoid the protrusion, and
wherein, where traveling of the movable body in which the wheel of the movable body passes the protrusion is permitted, the traveling control portion determines the travel route of the movable body to be a route that causes the wheel to pass the protrusion.

4. The traveling control system according to claim 1, wherein, where traveling of the movable body in which the wheel of the movable body passes the protrusion is permitted, the traveling control portion determines a travel speed of the movable body based on at least one of a state of the movable body and a condition of the road surface.

5. The traveling control system according to claim 1, wherein the traveling control portion controls traveling of the movable body such that a turning outer wheel of the movable body, which is located on an outer side in a turning state of the movable body, passes the protrusion of the road surface in the turning state of the movable body.

6. The traveling control system according to claim 1, wherein the movable body includes: a rear information obtaining portion configured to obtain a condition of the road surface after the wheel passes; and a rear information supply portion configured to supply, to the traveling control portion, information that is obtained by the rear information obtaining portion and that indicates the unevenness condition of the road surface behind the movable body.

7. The traveling control system according to claim 1, wherein the traveling control portion estimates a size of a protrusion of the road surface after the wheel passes the protrusion, based on at least one of a condition of the road surface and a state of the movable body.
